(19) United States
(12) Patent Application Publication
(10) Pub. No.: US 2010/0040448 A1
(43) Pub. Date: Feb. 18, 2010

(54) DEVICE CARRIAGE WITH INTEGRATED MOTOR PART

(75) Inventors: Markus Knorr, Augsburg (DE); Gerhard Matscheko, Starnberg (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschft, Munchen (DE)

(21) Appl. No.: 12/377,992

(22) PCT Filed: Aug. 13, 2007
(86) PCT No.: PCT/EP07/58351

§ 371 Date: Feb. 18, 2009

(30) Foreign Application Priority Data
Aug. 17, 2006 (DE) 10 2006 038 416.4

(51) Int. Cl. B65G 25/00

(52) U.S. Cl. 414/749.1

(57) ABSTRACT

A carriage of an electric machine has a carriage base for accommodating an object to be moved. The carriage base is fastened to a movable primary part of a linear motor. A seat is integrally formed on the carriage base and represents the housing or a housing part fastened in or to the movable primary part. The one-part design of the seat with the carriage base increases the stability of the entire carriage, allowing a reduced wall thicknesses of the carriage and eliminating the need for additional fastening elements securing the seat to the carriage base. The weight of the carriage to also reduced.

The present invention relates to a device carriage with a carriage base for accommodating an object to be transported, and a primary part or a secondary part of a linear motor, which is fastened on the carriage base. The term “device carriage” is in this case understood to mean any component of a device which is or can be provided with guides in order to move a body or a device component along the guide. Such device carriages are generally used in production machines, robots etc., but also in straight transport systems. The carriage is usually driven by a linear motor.

Linear motors are generally built-in motors, i.e. the motor components are made available to the user in a construction kit. The user must then produce the complete machine-building, mechatronic construction around the motor itself. Each component of the construction kit therefore needs to be developed to have sufficient intrinsic rigidity and is therefore often unnecessarily heavy.

Furthermore, measurement systems, connections, guides and the like need to be attached to the respective carriage of the linear motor used. The user therefore often has to screw on numerous adaptors. In this case, unfavorable positions for the components to be attached, for example the displacement measurement system, often need to be chosen for space-saving reasons.

The object of the present invention is therefore to propose a device carriage which has sufficient intrinsic rigidity, is as small as possible and is as light as possible.

According to the invention, this object is achieved by a device carriage with a carriage base for accommodating an object to be transported, and a primary part or a secondary part of a linear motor, which is fastened on the carriage base, a seat being integrally formed on the carriage base and being used as the housing or housing part of the primary part or the secondary part, and the primary part or the secondary part being fastened in or on the seat.

Advantageously, the carriage base therefore at the same time forms the motor housing, with the result that mechanical interfaces between the two components can be dispensed with. This increases the intrinsic rigidity or else a reduction in the wall thicknesses can be achieved given the same rigidity. Both cases save on space and weight.

Preferably, the primary part or the secondary part of the linear motor is cast into the seat. In this way, the rigidity of the drive can be further increased.

Furthermore, the seat of the carriage base for the primary part can have four or five side walls and be open on one or two sides. This results in a primary part which is substantially only open in the direction towards the secondary part and can be inserted into the seat from there. In this case, one or more openings can be arranged on one of the side walls in order to guide one or more electrical lines from the outside to the primary part. These openings can also be used for fitting plugs and strain-relief devices, for example.

Furthermore, the primary part can have a cooling device, one or more cooling lines of which is/are guided through one of the side walls. It is therefore not necessary to fit a special adaptor for cooling lines on the device carriage.

In accordance with a special embodiment, the device carriage according to the invention can be integrally connected to a housing of a machine component or to the machine component itself. In this case, the housing of the machine component or the machine component itself has the function of a device carriage, on which, in addition to the primary part, only guide elements for the linear movement need to be or are fitted.

The device carriage according to the invention can generally have a guide device in order to guide it along its movement. This guide device can in particular be mechanical or magnetic in nature.

In addition, as has already been mentioned for electrical lines and cooling lines, a mechanical interface for fitting a measurement system or a guide component can be integrated in the carriage base. This makes it possible to avoid separate adaptors which often mean a loss in rigidity and an increase in weight.

Finally, a housing for a measurement sensor system can also be integrally formed on the carriage base. This also makes it possible to increase the rigidity and reduce the total mass.

The present invention will now be explained in more detail with reference to the attached drawings, in which:

FIG. 1 shows a primary part housing in accordance with the prior art;

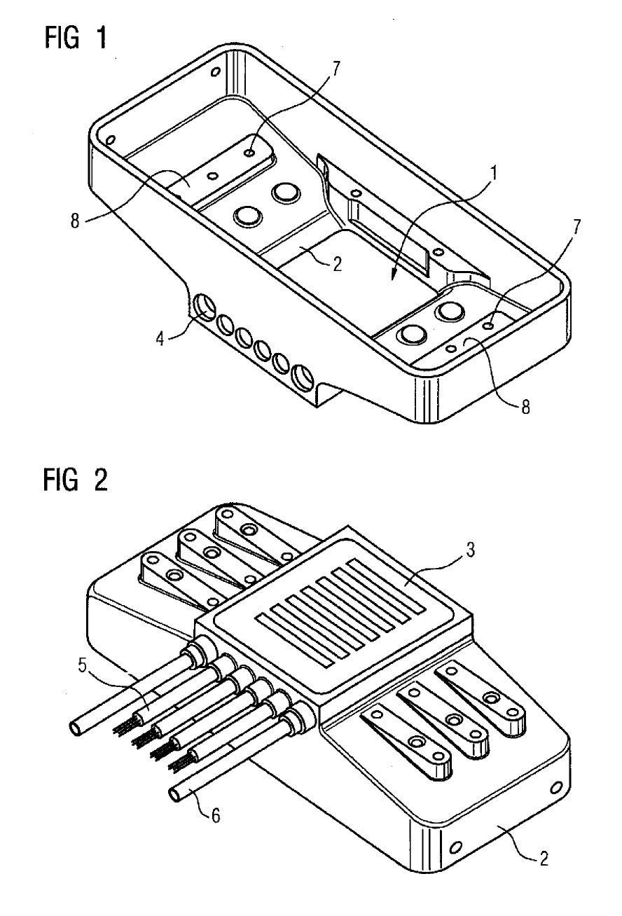

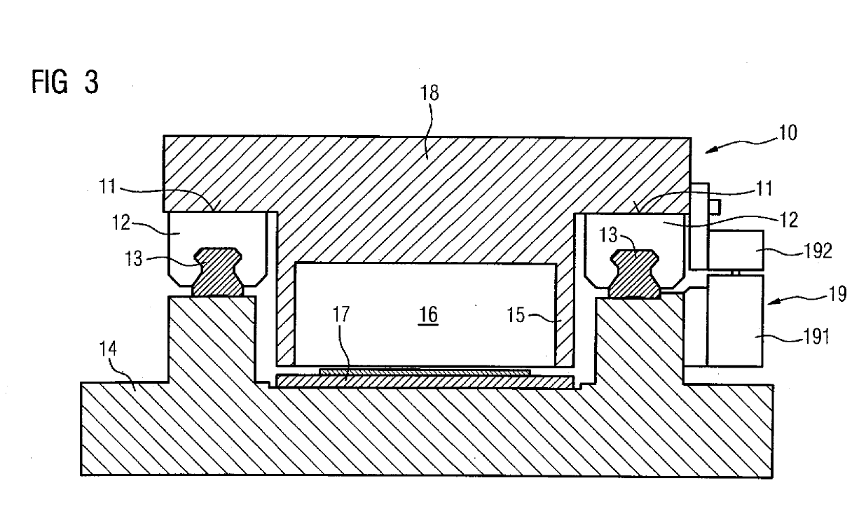

FIG. 2 shows the primary part housing from FIG. 1 with the primary part inserted;

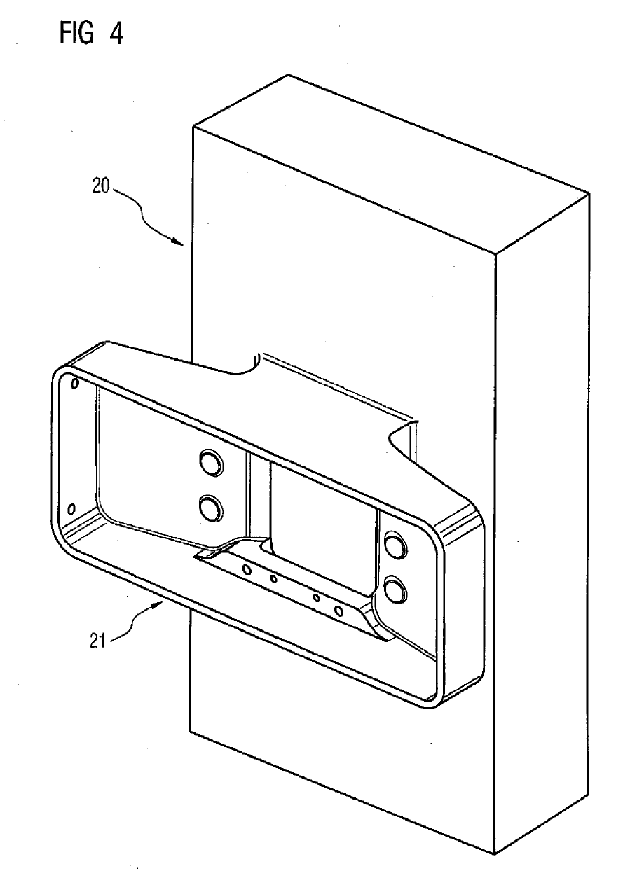

FIG. 3 shows a cross section through a machine bed with a device carriage according to the invention, and

FIG. 4 shows a perspective view of a device carriage according to the invention.

The exemplary embodiments described in more detail below represent preferred embodiments of the present invention.

For better understanding of the invention, primary part housings in accordance with the prior art will first be briefly explained with reference to FIGS. 1 and 2. Accordingly, a primary part housing, as is reproduced in FIG. 1, represents a separate component part. In the present case, it is cast from plastic or aluminum. In its central region, the housing has an opening 1, which is delimited by four side walls 2. According to FIG. 2, a primary part 3 is inserted into this opening 1. While FIG. 1 shows the primary part housing from the upper side, FIG. 2 shows said primary part housing from the lower side, i.e. from the side which is opposite the secondary part. It can be seen that the active surface of the primary part 3 is not covered by the primary part housing. In addition, bores 4 are provided on one of the side walls 2 of the opening 1, with electrical lines 5 and cooling lines 6 being guided through said bores 4, as shown in FIG. 2.

The primary part housing is intended to be fitted on a user-specific carriage. For this purpose, special bores 7 are arranged on the primary part housing, which bores 7 make it possible to screw or otherwise fasten the primary part housing on the corresponding carriage. In order that the wall thickness in the region of the bores 7 is sufficiently high, a housing reinforcement 8 is integrally formed in this region of the bores 7. As a result of the primary part housing being screwed to a carriage, there are a plurality of disadvantages: firstly, the carriage/primary part housing arrangement is overall less rigid owing to the screw-type connection, and secondly the reinforcements 8 and the fastening screws result in weights which reduce the dynamics of the linear motor.

According to the invention, the device carriage 10 reproduced schematically in cross section in FIG. 3 is therefore provided. This device carriage 10 has cutouts 11, to which two parallel guide carts 12 may be integrally fastened. Each of the guide carts 12 runs on a corresponding guide rail 13, as a result of which the movement direction of the linear motor is defined. The guide rails 13 themselves are fitted on a machine bed 14.

Side walls 15, which form a seat for a primary part 16 of a linear motor, are integrally formed on the device carriage 10 between the guide carts 12. A secondary part 17 of the linear motor, which is fastened on the machine bed 14, is positioned opposite the primary part 16.

As a result of the fact that the seat of the primary part, i.e. the housing of the primary part with the side walls 15, is integrally connected to the carriage base 18, all of the known mechatronic problems, such as oscillations, rigidity, etc., can be managed significantly more effectively. For this purpose, fitting elements are also arranged on the device carriage 10 in order to be able to attach, for example, measurement systems, guides and the like directly on the machine carriage and therefore also directly on the primary part housing. No additional adaptors are therefore required for the fitting process, which adaptors represent potential weak points on the linear motor. The mass of the overall system is thereby reduced considerably.

As a result of the fact that fastening elements for fastening the primary part housing on the carriage, but also fixedly predetermined connection possibilities for electronics and cooling do not need to be provided, as is the case in standard motors, the variance in terms of connection possibilities as regards cable feeder direction, cooling connection etc. is a multiple greater.

FIG. 4 shows a device carriage according to the invention in a perspective view. A primary part housing 21 or a seat for the primary part is integrally formed on the carriage base 20. The carriage section forming the primary part housing 21 no longer has a fitting device for fastening on the carriage base 20 since these two parts are connected integrally to one another or are cast. This results necessarily in improved rigidity. In addition, no screws and no reinforcements 8 (cf. FIG. 1) for screw-type fastenings then need to be provided on a housing section. Owing to the improved rigidity, overall the wall thicknesses can be reduced. Alternatively, the secondary part of the linear motor can also be accommodated in the housing 21.

In FIG. 3, a measurement system 19 is symbolically attached to the carriage 10. In the present case, this is a distance measurement system which has a probe 191, which is fastened on the machine bed 14, and a material measure 192, which is fastened on the carriage base 18. The position or movement of the primary part 16 with respect to the secondary part 17 or the carriage 10 with respect to the machine bed 14 can thus be determined.

In practice, the carriage section forming the primary part housing is configured in such a way that the user can screw his carriage onto the primary part from above. Alternatively, the primary part is cast directly into the seat formed by the side walls 15 as early as during manufacture of the carriage. As a result, the carriage can be delivered already with the primary part. This means that the user can configure his carriage as desired and only needs to provide space for the primary part. For this purpose, only the required number of side walls (preferably 5) on the carriage need to be formed from the point of view of the user.

The block 192 illustrated in FIG. 3 can also represent a housing for a motor sensor system. This housing is then integrally connected to the carriage base 18 for reasons of weight and rigidity as well.

1.-9. (canceled)

10. A device carriage, comprising
a linear motor having a movable primary part and a secondary part, and
a carriage base for accommodating an object to be transported, said carriage base has a seat integrally formed with the carriage base and fastened on the movable primary part of the linear motor by casting.

11. The device carriage of claim 10, wherein the seat has four or five side walls and is open on one or two sides.

12. The device carriage of claim 11, wherein one of the side walls has at least one opening for guiding an external electrical line into the movable primary part.

13. The device carriage of claim 11, wherein at least one cooling line is guided through one of the side walls.

14. The device carriage of claim 11, wherein the device carriage is integrally connected to a machine component or to a housing of a machine component.

15. The device carriage of claim 11, further comprising a guide device guiding the device carriage along a travel path.

16. The device carriage of claim 11, further comprising a mechanical interface integrally formed as a single piece with carriage basic body and configured for connection to a measurement system or a guide component.
